(19) United States
(12) Patent Application Publication
(10) Pub. No.: US 2012/0218392 A1
(43) Pub. Date: Aug. 30, 2012

(54) Stereoscopic Video Display Device

(75) Inventor: Nobutoshi Fujinami, Osaka (JP)

(73) Assignee: PANASONIC CORPORATION, Kadoma-shi, Osaka (JP)

(21) Appl. No.: 13/504,131

(22) PCT Filed: Jan. 13, 2011
(86) PCT No.: PCT/JP2011/000148

§ 371 Date: Apr. 26, 2012

(30) Foreign Application Priority Data
Jan. 13, 2010 (JP) 2010-004714

(51) Int. Cl. H04N 13/04

(52) U.S. Cl. 348/51; 348/E13.075

(57) ABSTRACT

Provided is a stereoscopic video display device having increased convenience which simultaneously displays a plurality of stereoscopic video footages on one screen, thereby allowing a viewer to simultaneously view the plurality of stereoscopic video footages. A video control section 240 simultaneously displays first video 250 and second video 260 in given positions on a screen 220, performs adjustment so as to decrease or increase the parallax between right-eye video 251 and left-eye video 252 of the first video 250, or performs adjustment so as to decrease or increase the parallax between right-eye video 261 and left-eye video 262 of the second video 260, in accordance with the parallax between the right-eye video 251 and the left-eye video 252 of first video 250.

### TECHNICAL FIELD

The present invention relates to stereoscopic video display devices that exploit parallax between the eyes to display stereoscopic video.

### BACKGROUND ART

The development of stereoscopic video display devices that use plasma display panels or liquid crystal panels to display stereoscopic video has been actively underway in recent years. Stereoscopic video display devices exploiting parallax between the eyes typically display, in alternation on a display-panel screen, right-eye video and left-eye video each having parallax with respect to the other. When the right-eye video is screened, the video is seen with the right eye, and when the left-eye video is screened, the video is seen with the left eye. Since these right-eye and left-eye video views have parallax between them, the video can be seen stereoscopically. With such stereoscopic video, the sense of depth and the sense of projection of the video change according to the amount of parallax between the right-eye video and the left-eye video. When the amount of parallax is large, the depth and the projection also increase, and when the amount of parallax is small, the depth and the projection also decrease.

In order to view the right-eye video with the right eye and the left-eye video with the left eye in a stereoscopic video display device of this sort, a shutter-type visor, for example, is used. In a shutter-type visor, liquid crystal filters that switch between passing and blocking light are arranged in the right-eye lens and the left-eye lens. Passage and blocking of light is switched by the opening and closing of the liquid-crystal-filter shutters, enabling the right-eye video to be viewed by the right eye and enabling the left-eye video to be viewed by the left eye.

The repeated opening and closing of the shutters enables a viewer to see stereoscopic video through the right-eye video and the left-eye video having parallax. Such stereoscopic video display devices using the shutter-type visor are disclosed, for example, in Patent Literature 1 and Patent Literature 2.

In addition, Patent Literature 3 discloses a configuration whereby display of not only three-dimensional stereoscopic video but also of ordinary two-dimensional video is made possible in a stereoscopic video display device using a shutter-type visor. That is, the stereoscopic video display device is rendered to allow enjoyment of video also in situations where the shutter-type visor is not used. In accordance with a signal selection switch, this stereoscopic video display device displays three-dimensional stereoscopic video as a master screen on the display-panel screen, and displays ordinary two-dimensional video as a slave screen.

### CITATION LIST

### Patent Literature

[PTL 1] Japanese Laid-open Patent Publication No. 2000-36939

[PTL 2] Japanese Laid-open Patent Publication No. H10-240212

[PTL 3] Japanese Laid-open Patent Publication No. H1-144797

### SUMMARY OF THE INVENTION

### Problems to be Solved by the Invention

The above-described conventional stereoscopic video display devices either display three-dimensional stereoscopic video or dual video—three-dimensional stereoscopic video and ordinary two dimensional video—on their display-panel screen. Nevertheless, there is no displaying of at least two three-dimensional stereoscopic video footages simultaneously on one screen. Conventional stereoscopic video display devices lack the convenience that would allow viewers to simultaneously watch a plurality of three-dimensional stereoscopic video footages displayed on one screen at the same time. Moreover, even if a plurality of stereoscopic video footages were simultaneously displayed, if a viewer were to watch a plurality of stereoscopic video footages whose sense of depth and sense of projection differ, the viewer would likely undergo an uncomfortable feeling.

The present invention has been made to solve the above problems. An object of the present invention is to provide a stereoscopic video display device having improved convenience which simultaneously displays a plurality of stereoscopic video footages on one screen, thereby allowing a viewer to simultaneously view the plurality of stereoscopic video footages.

### Solution to the Problems

In order to attain the above object, the present invention is directed to a stereoscopic video display device configured to display a plurality of stereoscopic video footages, comprising: a display panel in which a screen for displaying the plurality of stereoscopic video footages is arranged; and a video control section configured to control the display of the plurality of stereoscopic video footages; wherein the plurality of stereoscopic video footages respectively include right-eye video and left-eye video each having parallax with respect to the other, and the video control section simultaneously displays the plurality of stereoscopic video footages in given positions on the screen, and changes, in accordance with the parallax between the right-eye video and the left-eye video in one stereoscopic video footage among the plurality of stereoscopic video footages, the parallax between the right-eye video and the left-eye video in said one stereoscopic video footage or in another of the stereoscopic video footages, so as to decrease or increase the parallax between the right-eye video and the left-eye video in said one stereoscopic video footage or in said other stereoscopic video footage.

### Advantageous Effects of the Invention

According to the stereoscopic video display device of the present invention, since the video control section simultaneously displays the plurality of stereoscopic video footages in given positions on the screen, the viewer can simultaneously view the plurality of stereoscopic video footages and convenience is improved.

In particular, the video control section adjusts, in accordance with the parallax between the right-eye video and the left-eye video in one stereoscopic video among the plurality of stereoscopic video footages, the parallax between the right-eye video and the left-eye video in the one stereoscopic video or another stereoscopic video, so as to decrease or increase the parallax between the right-eye video and the left-eye video in the one stereoscopic video or said another stereoscopic video. Accordingly, it is possible to decrease the uncomfortableness of the viewer even when the viewer simultaneously views a plurality of stereoscopic video footages having different sense of depth and sense of projection.

In a case where a plurality of stereoscopic video footages are simply displayed simultaneously on one screen, the viewer may feel uncomfortable due to different sense of depth and different sense of projection among the stereoscopic video footages. However, in the stereoscopic video display device of the present invention, the parallax between the right-eye video and the left-eye video in one stereoscopic video or another stereoscopic video is adjusted such that the parallax between the right-eye video and the left-eye video in the one stereoscopic video or said another stereoscopic video is decreased or increased, in accordance with the parallax between the right-eye video and the left-eye video in the one stereoscopic video. Therefore, the degree of difference in the sense of depth and in the sense of projection is restricted, and thus, the uncomfortableness of the viewer can be decreased. Moreover, since the uncomfortableness of the viewer is decreased, the viewer can also have less fatigue in eyes.

### BRIEF DESCRIPTION OF THE DRAWINGS

FIG. 1 is a block diagram showing a relationship between a shutter-type visor and a stereoscopic video display device according to an embodiment of the present invention.

FIG. 2 is a front view of a display panel at a time when a video is displayed on a stereoscopic video display device according to an embodiment of the present invention.

FIG. 3 is a schematic diagram for describing video including right-eye video and left-eye video.

FIG. 4 is a front view of a display panel at a time when a plurality of video footages are displayed.

FIG. 5 is a schematic diagram for describing first video that has been reduced, the first video including right-eye video and left-eye video.

FIG. 6 is a schematic diagram for describing second video that has been reduced, the second video including right-eye video and left-eye video.

FIG. 7 is a front view of a display panel 230 at a time when a plurality of video footages having different parallaxes from each other are displayed.

FIG. 8 is a front view of the display panel 230 showing states before and after parallaxes have been adjusted.

FIG. 9A is a block diagram showing an example of a specific configuration of a video control section 240.

FIG. 9B is a block diagram showing an example of a specific configuration of the video control section 240.

FIG. 9C is a block diagram showing an example of a specific configuration of the video control section 240.

FIG. 10A is a flow chart showing an example of operations performed by a stereoscopic video display device 200 when it adjusts parallaxes.

FIG. 10B is a flow chart showing an example of operations performed by the stereoscopic video display device 200 when it adjusts parallaxes.

FIG. 11A shows a method of calculating a convergence point of first video 250.

FIG. 11B shows a method of calculating a convergence point of second video 260.

FIG. 12A is a flow chart showing an example of operations performed by the stereoscopic video display device 200 when it adjusts the convergence point of the second video 260 to the convergence point of the first video 250.

FIG. 12B is a flow chart showing an example of operations performed by the stereoscopic video display device 200 when it adjusts the convergence point of the first video 250 and the convergence point of the second video 260 to a middle point.

FIG. 12C is a flow chart showing an example of operations performed by the stereoscopic video display device 200 when it causes the parallax of the second video 260 to fall within a range between the maximum value and the minimum value of the parallax of the first video 250

FIG. 12D is a flow chart showing an example of operations performed by the stereoscopic video display device 200 when it causes the parallaxes of the first video 250 and the second video 260 to fall within a range between a reference maximum value and a reference minimum value.

FIG. 13 is a front view of the display panel 230 at a time when a plurality of stereoscopic video footages are displayed.

FIG. 14 is a front view of the display panel 230 at a time when a plurality of stereoscopic video footages are displayed in thumbnails.

FIG. 15 is a front view of a plurality of display panels at a time when video footages are displayed on the stereoscopic video display devices 200, respectively.

### DESCRIPTION OF EMBODIMENTS

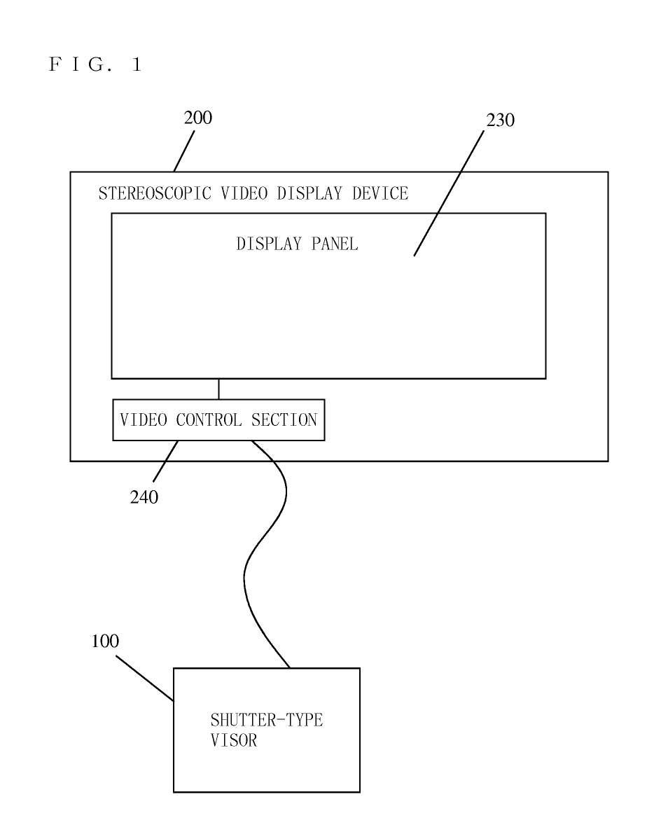

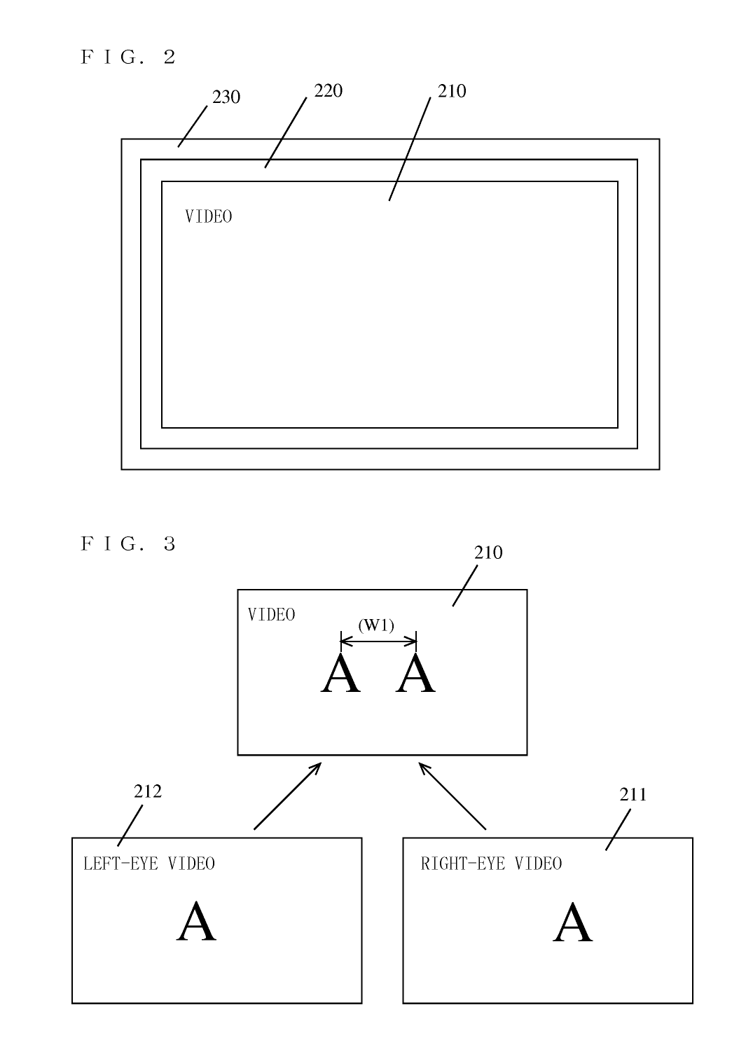

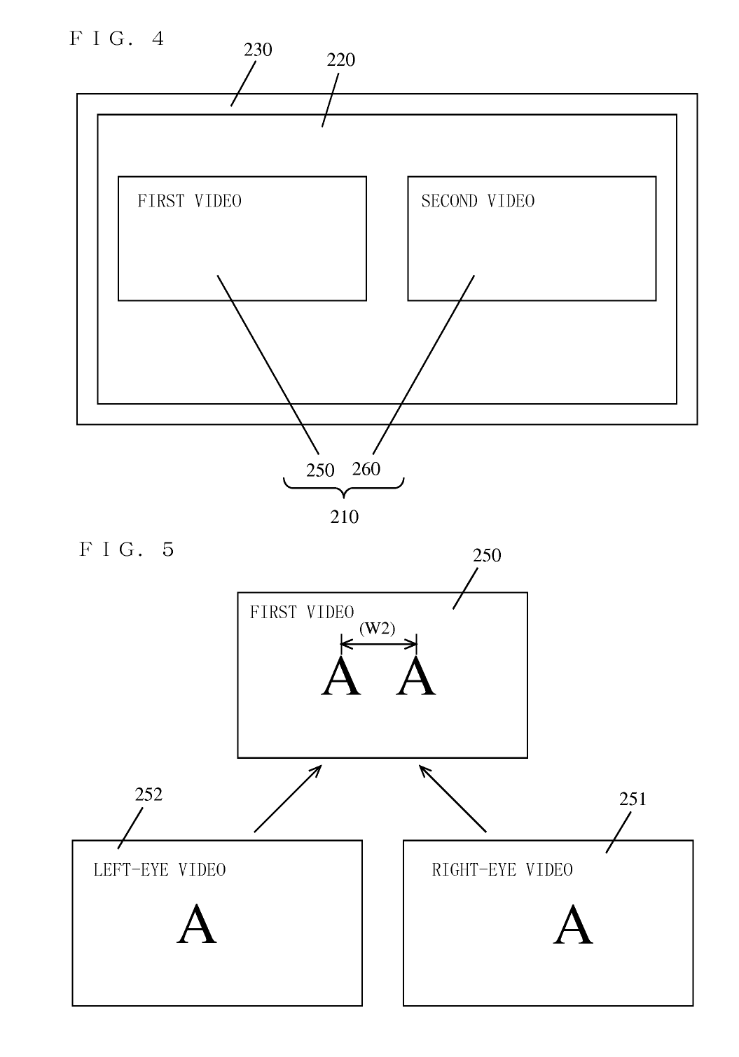

Hereinafter a stereoscopic video display device according to an embodiment of the present invention will be described with reference to the drawings. FIG. 1 is a block diagram showing a relationship between a shutter-type visor and a stereoscopic video display device according to an embodiment of the present invention. FIG. 2 is a front view of a display panel at a time when a video is displayed on a stereoscopic video display device. FIG. 3 is a schematic diagram for describing a video including right-eye video and left-eye video.

<Relationship Between a Shutter-Type Visor and a Stereoscopic Video Display Device 200>

First, the relationship between a shutter-type visor 100 and a stereoscopic video display device 200 will be described. In FIG. 1, the stereoscopic video display device 200 includes a display panel 230 in which a screen that displays a video is arranged, and a video control section 240 which controls the display of the video. In FIG. 2, a screen 220 displaying video 210 is arranged in the display panel 230. As the display panel 230, a plasma display panel, a liquid crystal panel, or the like is used, for example.

As shown in FIG. 3, the video 210 includes right-eye video 211 and left-eye video 212 having a parallax therebetween. The video control section 240 performs controls such that the right-eye video 211 and the left-eye video 212 having the parallax therebetween are alternately displayed on the screen 220 of the display panel 230. When the right-eye video 211 is displayed, the viewer views the right-eye video 211 with the right eye, and when the left-eye video 212 is displayed, the viewer views the left-eye video 212 with the left eye. Since the right-eye video 211 and the left-eye video 212 have the parallax therebetween, the video 210 is stereoscopically viewed.

With reference to FIG. 3, a character “A” is displayed on each of the right-eye video 211 and the left-eye video 212. When the right-eye video 211 and the left-eye video 212 are alternately displayed on the screen 220 of the display panel 230, the viewer sees them as a video having a parallax (W1). That is, the viewer sees the video 210 in a three-dimensional manner. With respect to the video 210, its sense of depth and its sense of projection are changed according to the parallax (W1) between the right-eye video 211 and the left-eye video 212. When the parallax (W1) is large, the depth and the projection are also increased, and when the parallax (W1) is small, the depth and the projection are also decreased.

In order to view the right-eye video 211 with the right eye and the left-eye video 212 with the left eye, the shutter-type visor 100 is used, for example. In the shutter-type visor 100, a liquid crystal filter that switches passage and blocking of light is provided for each of the right-eye lens and the left-eye lens. By opening and closing the shutters of the liquid crystal filters, passage and blocking of light are switched.

Specifically, in synchronization with the timing of switching the right-eye video 211/the left-eye video 212 to be displayed on the display panel 230, the timing of opening/closing the shutters of the liquid crystal filters provided on the right-eye lens and the left-eye lens is switched. That is, in synchronization with the timing at which the right-eye video 211 is to be displayed, the shutter of the liquid crystal filter provided on the right-eye lens is opened to pass light, and the shutter of the liquid crystal filter provided on the left-eye lens is closed to block light, thereby allowing only the right eye to see the right-eye video 211. In synchronization with the timing at which the left-eye video 212 is to be displayed, the shutter of the liquid crystal filter provided on the left-eye lens is opened to pass light, and the shutter of the liquid crystal filter provided on the right-eye lens is closed to block light, thereby allowing only the left eye to see the left-eye video 212. The timing of switching the right-eye video 211 and the left-eye video 212 and the timing of opening/closing the shutters of the liquid crystal filters are synchronized through wireless or wired connection between the display panel 230 and the visor 100. Repeated opening/closing of the shutters allows the viewer to see three-dimensional video 210 based on the right-eye video 211 and the left-eye video 212 having a parallax therebetween.

<A Case where a Plurality of the Video Footages 210 are Displayed on the Display Panel 230>

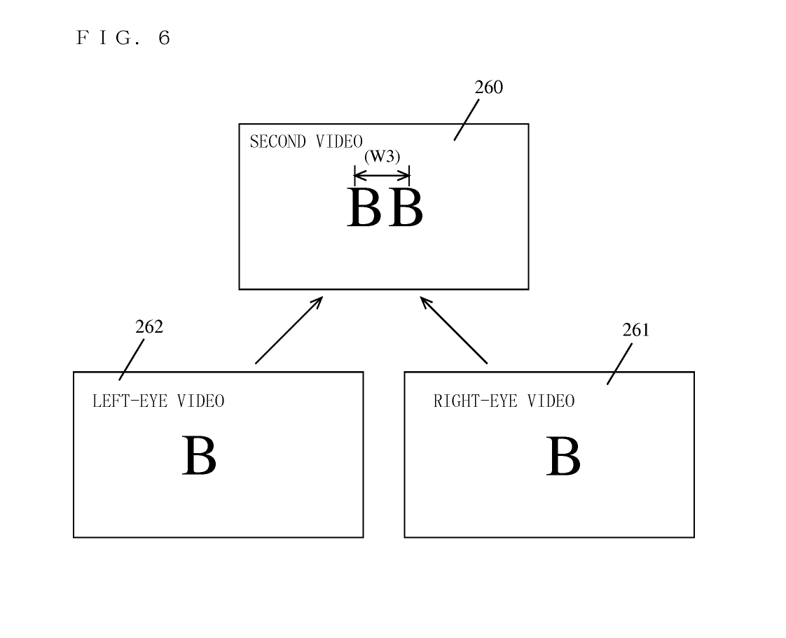

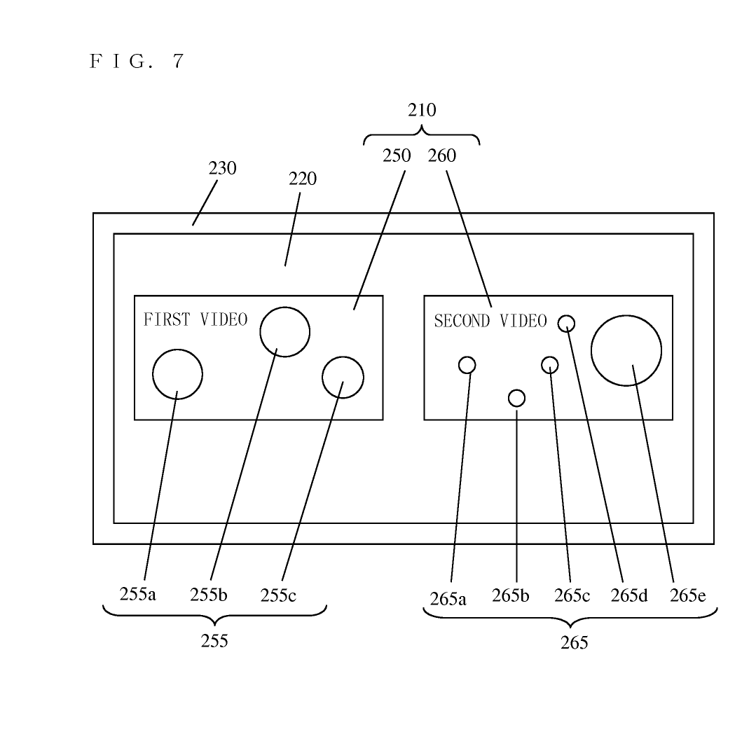

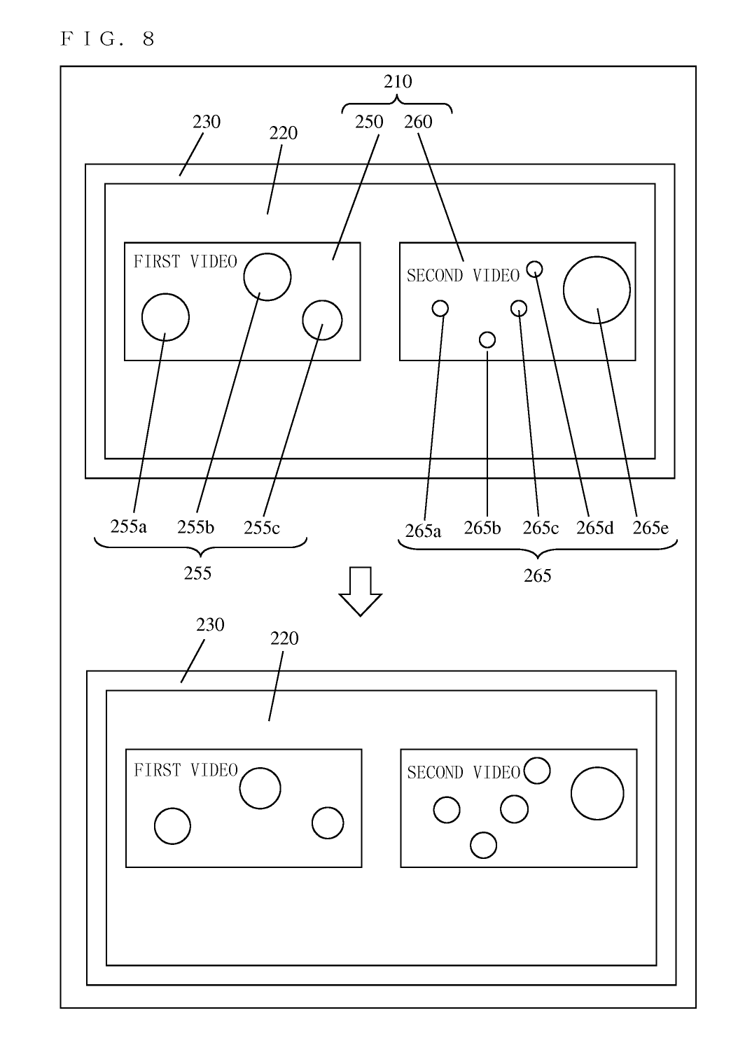

Next, a case where a plurality of the video footages 210 are displayed on the display panel 230 will be described. FIG. 4 is a front view of a display panel at a time when a plurality of video footages are displayed. FIG. 5 is a schematic diagram for describing a first video that has been reduced, the first video including right-eye video and left-eye video. FIG. 6 is a schematic diagram for describing the second video that has been reduced, the second video including right-eye video and left-eye video.

In FIG. 4, first video 250 and second video 260 are simultaneously displayed in given positions on the screen 220 of the display panel 230. The contents of the first video 250 and the second video 260 may be different or the same with each other, or may be video contents received from a broadcasting company or video contents recorded on a medium, that is, various types of video contents can be used as the first video 250 and the second video 260. As shown in FIG. 4, the first video 250 and the second video 260 have been processed into video footages reduced relative to the original video 210 by the video control section 240 and are simultaneously displayed on the screen 220. Similarly to the original video 210, the reduced first video 250 includes right-eye video 251 and left-eye video 252 having a parallax therebetween (see FIG. 5). Moreover, similarly to the original video 210, the reduced second video 260 includes right-eye video 261 and left-eye video 262 having a parallax therebetween (see FIG. 6).

<Differences Between Parallaxes Between a Plurality of the Video Footages 210>

Next, differences between parallaxes between a plurality of the video footages 210 will be described.

First, the reduced first video 250 will be described. With respect to the first video 250, a character “A” is displayed in each of the right-eye video 251 and the left-eye video 252. When the right-eye video 251 and the left-eye video 252 are alternately displayed on the screen 220 of the display panel 230, the viewer sees the first video 250 as a stereoscopic video having a parallax (W2). That is, the viewer can see the first video 250 as a stereoscopic video having the sense of projection and the sense of depth according to the parallax (W2).

Here, when the reduced first video 250 is compared with the original video 210 before being reduced, the parallax (W2) of the first video 250 has become smaller than the parallax (W1) of the original video 200. The decrease in the parallax causes the first video 250 to have decreased sense of projection and decreased sense of depth, compared with the original video 210.

Next, the reduced second video 260 will be described. With respect to the second video 260, a character “B” is displayed in each of the right-eye video 261 and the left-eye video 262. When the right-eye video 261 and the left-eye video 262 are alternately displayed on the screen 220 of the display panel 230, the viewer sees the second video 260 as a stereoscopic video having a parallax (W3). That is, the viewer can see the second video 260 as a stereoscopic video having the sense of projection and the sense of depth according to the parallax (W3).

Here, when the reduced second video 260 is compared with the original video 210 before being reduced, the parallax (W3) of the second video 260 has become smaller than the parallax (W1) of the original video 210. The decrease in the parallax causes the second video 260 to have decreased sense of projection and decreased sense of depth, compared with the original the video 210.

Further, when the first video 250 is compared with the second video 260, the parallax (W3) of the second video 260 has become smaller than the parallax (W2) of the first video 250. The difference between the parallaxes causes the second video 260 to have decreased sense of projection and decreased sense of depth, compared with the first video 250. In this manner, since the first video 250 and the second video 260 have been reduced, compared with the original video 210, the parallaxes thereof have also become small.

Moreover, when the first video 250 and the second video 260 are simultaneously displayed on the screen 220, if the parallax (W2) of the first video 250 and the parallax (W3) of the second video 260 are different from each other, the viewer feels that the sense of projection and the sense of depth are also different between the first video 250 and the second video 260. Moreover, there may be a case where the sense of projection and the sense of depth are greatly different between the first video 250 and the second video 260, in accordance with video production designs and the like.

<Difference Between Parallaxes Due to a Plurality of Objects 255 and 256>

Next, difference between parallaxes due to a plurality of objects 255 and 256 will be described. FIG. 7 is a front view of the display panel 230 at a time when a plurality of the video footages 210 having different parallaxes from each other are displayed.

In FIGS. 5 to 7, the first video 250 and the second video 260 are simultaneously displayed at predetermined positions on the screen 220 of the display panel 230. The first video 250 and the second video 260 have been processed into video footages reduced relative to the original video 210 by the video control section 240, and are simultaneously displayed on the screen 220. Similarly to the original video 210, the reduced first video 250 includes the right-eye video 251 and the left-eye video 252 having a parallax therebetween. Moreover, similarly to the original video 210, the reduced second video 260 includes the right-eye video 261 and the left-eye video 262 having a parallax therebetween.

First, the reduced first video 250 will be described. With respect to the first video 250, a plurality of objects 255 having parallaxes therebetween are displayed on the right-eye video 251 and the left-eye video 252. When the right-eye video 211 and the left-eye video 212 are alternately displayed on the screen 220 of the display panel 230, the viewer sees the plurality of objects 255 as stereoscopic video footages. That is, the viewer can see stereoscopic video footages having the sense of projection and the sense of depth according to the parallaxes of the respective objects 255.

Next, the reduced second video 260 will be described. With respect to the second video 260, a plurality of objects 265 having parallaxes therebetween are displayed on the right-eye video 261 and the left-eye video 262. When the right-eye video 261 and the left-eye video 262 are alternately displayed on the screen 220 of the display panel 230, the viewer sees the plurality of objects 265 as stereoscopic video footages. That is, the viewer can see stereoscopic video footages having the sense of projection and the sense of depth according to the parallaxes of the respective objects 265.

With respect to each of the objects 255 and 265 in the first video 250 and the second video 260, a larger size thereof means a greater parallax, and thus, a greater sense of projection and a greater sense of depth. That is, with respect to FIG. 7, the parallaxes of three objects 255a, 255b, and 255c in the first video 250 are greater than the parallaxes of four objects 265a, 265b, 265c, and 265d in the second video 260. Therefore, the three objects 255a, 255b, and 255c in the first video 250 have greater sense of projection and greater sense of depth than the four objects 265a, 265b, 265c, and 265d in the second video 260. Meanwhile, the second video 260 includes an object 265e that has the greatest diameter (an object having the greatest parallax). Therefore, the sense of projection and the sense of depth of the object 265e are the greatest. Although the parallaxes of the objects 255a, 255b, and 255c in the first video 250 and of the objects 265a, 265b, 265c, 265d, and 265e in the second video 260 are different from one another, the parallax of the first video 250 is greater than the parallax of the second video 260 on the whole.

As described above, since the first video 250 and the second video 260 have different sense of projection and sense of depth, when the first video 250 and the second video 260 are simultaneously displayed on one screen 220, a viewer may feel uncomfortable.

<Method for Adjusting Parallaxes of the Plurality of the Video Footages 210>

Next, a method for adjusting the parallaxes of the plurality of the video footages 210 will be described. FIG. 8 is a front view of the display panel 230 showing states before and after parallaxes have been adjusted.

In FIGS. 5 to 8, a case is assumed in which the parallax between the right-eye video 251 and the left-eye video 252 of the first video 250 is greater than the parallax between the right-eye video 261 and the left-eye video 262 of the second video 260. In such a case, in accordance with the parallax between the right-eye video 251 and the left-eye video 252 of the first video 250, the video control section 240 performs adjustment so as to decrease the parallax between the right-eye video 251 and the left-eye video 252 of the first video 250. Alternatively, the video control section 240 performs adjustment so as to increase the parallax between the right-eye video 261 and the left-eye video 262 of the second video 260.

In contrast, a case is assumed in which the parallax between the right-eye video 251 and the left-eye video 252 of the first video 250 is smaller than the parallax between the right-eye video 261 and the left-eye video 262 of the second video 260. In such a case, in accordance with the parallax between the right-eye video 251 and the left-eye video 252 of the first video 250, the video control section 240 performs adjustment so as to increase the parallax between the right-eye video 251 and the left-eye video 252 of the first video 250. Alternatively, the video control section 240 performs adjustment so as to decrease the parallax between the right-eye video 261 and the left-eye video 262 of the second video 260.

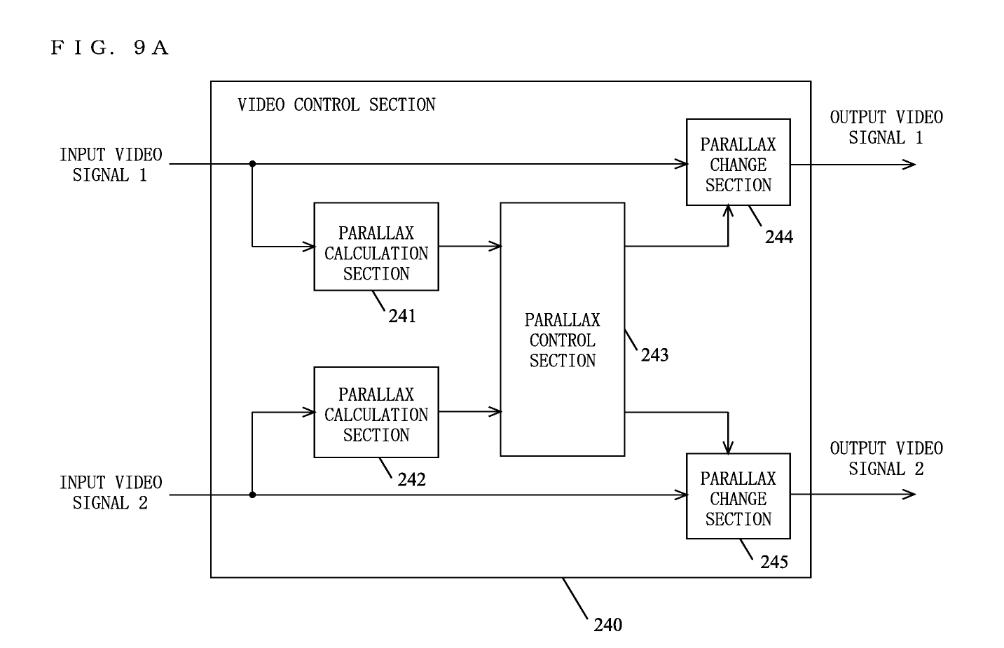

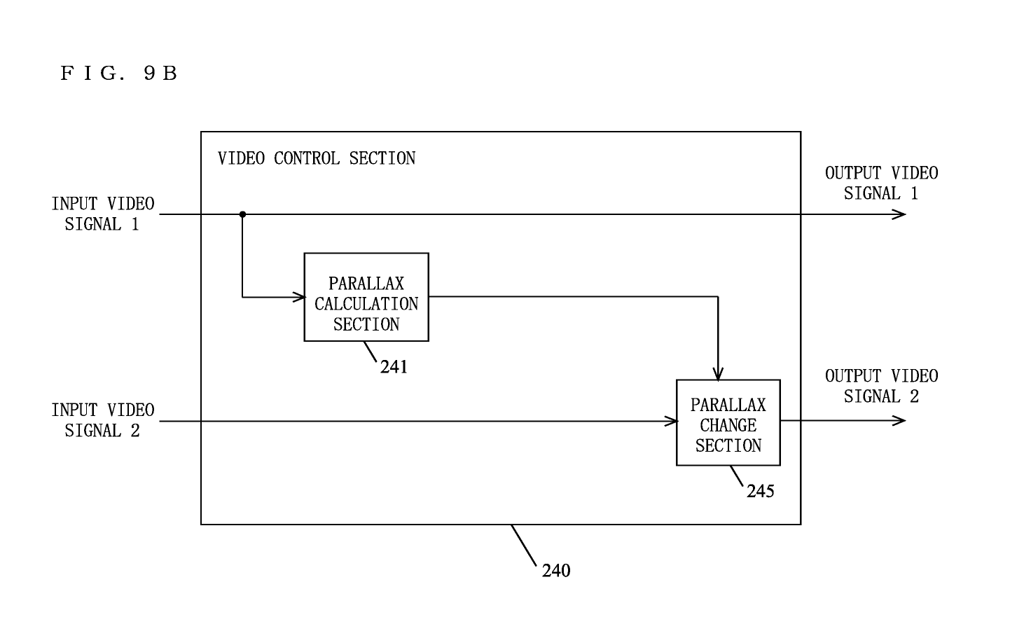

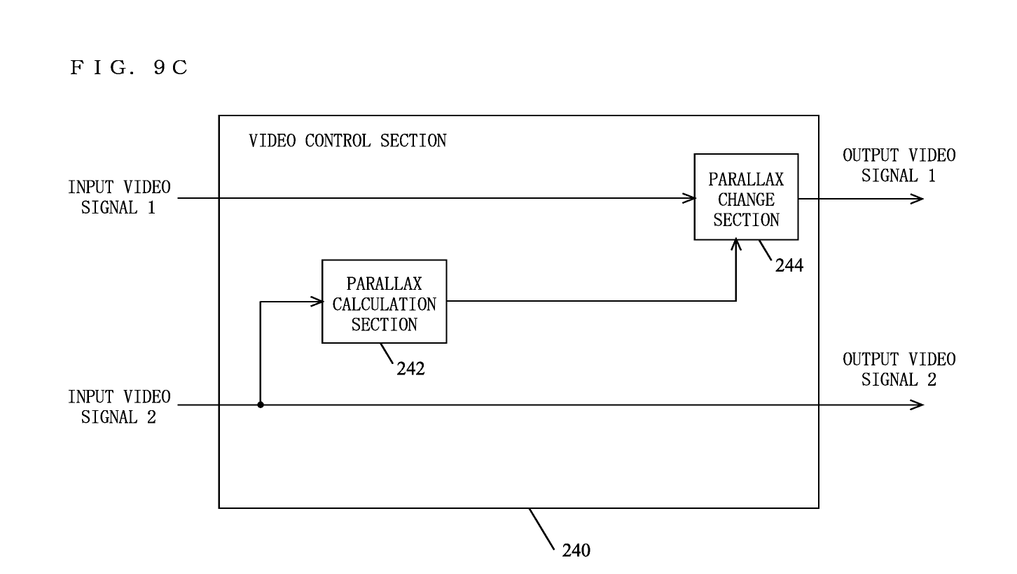

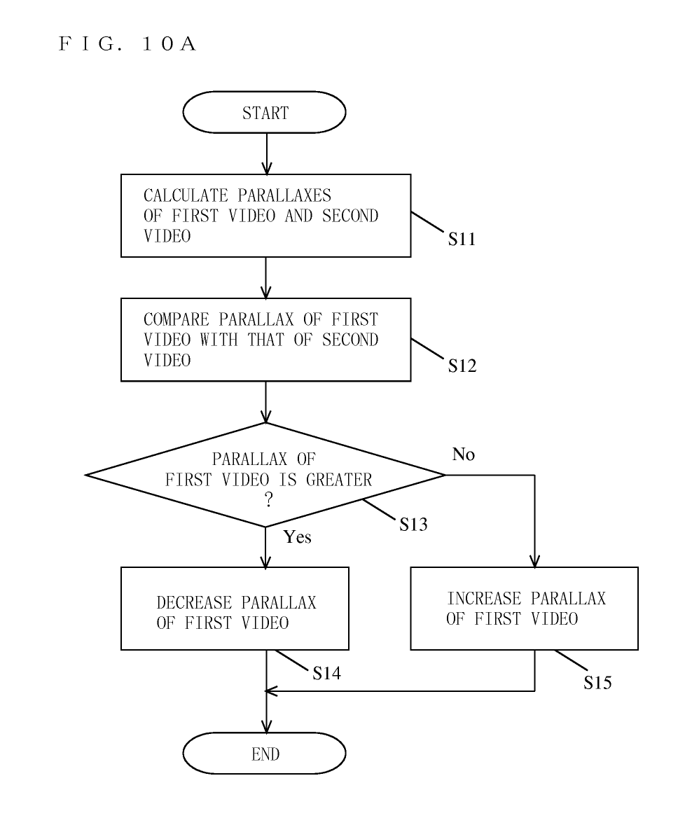

An example of a specific configuration of the video control section 240 will be described. FIG. 9A is a block diagram showing an example of a specific configuration of the video control section 240. With reference to FIG. 9A, the video control section 240 includes a parallax calculation section 241, a parallax calculation section 242, a parallax control section 243, a parallax change section 244, and a parallax change section 245. An input video signal 1 including the first video 250 is inputted to the parallax calculation section 241. The parallax calculation section 241 calculates the parallax between the right-eye video and the left-eye video in the first video 250, based on the input video signal 1. An input video signal 2 including the second video 260 is inputted to the parallax calculation section 242. The parallax calculation section 242 calculates the parallax between the right-eye video and the left-eye video in the second video 260, based on the input video signal 2. The parallax control section 243 controls the parallax between the right-eye video and the left-eye video in the first video 250 or the second video 260, so as to decrease or increase the parallax between the right-eye video and the left-eye video in the first video 250 or the second video 260, in accordance with the parallax between the right-eye video and the left-eye video in the first video 250 or the second video 260 of the first video 250 and the second video 260.

For example, the parallax control section 243 compares the parallax between the right-eye video and the left-eye video in the first video 250 with the parallax between the right-eye video and the left-eye video in the second video 260, and when the parallax between the right-eye video and the left-eye video in the first video 250 is greater than the parallax between the right-eye video and the left-eye video in the second video 260, the parallax control section 243 controls the parallax between the right-eye video and the left-eye video in the first video 250 and the parallax between the right-eye video and the left-eye video in the second video 260, such that the parallax between the right-eye video and the left-eye video in the first video 250 is decreased and the parallax between the right-eye video and the left-eye video in the second video 260 is increased. The parallax change section 244 changes the parallax between the right-eye video and the left-eye video in the first video 250 in accordance with the control by the parallax control section 243. The parallax change section 245 changes the parallax between the right-eye video and the left-eye video in the second video 260 in accordance with the control by the parallax control section 243.

It should be noted that the parallax calculation sections 241 and 242 may calculate convergence points of the plurality of stereoscopic video footages, respectively, and the parallax control section 243 may control the parallax between the right-eye video and the left-eye video in the first video 250 or the second video 260, based on the convergence point of the first video 250 and the convergence point of the second video 260. The method of calculating the convergence point will be described later.

As shown in FIG. 9B, the video control section 240 may be configured without the parallax calculation section 242, the parallax control section 243, and the parallax change section 244. In FIG. 9B, the video control section 240 includes the parallax calculation section 241 and the parallax change section 245. In this case, the parallax calculation section 241 calculates the parallax between the right-eye video and the left-eye video in the first video 250, based on the input video signal 1. The parallax change section 245 changes the parallax between the right-eye video and the left-eye video in the second video 260 to the parallax between the right-eye video and the left-eye video in the first video 250. In this case, the parallax of the first video 250 is not changed, and only the parallax of the second video 260 is changed. When such processing is performed, for example, between a video that the user of the device wants to view mainly and a video that the user wants to view on a secondary basis, a video used as a reference for adjusting the parallax can be switched. For example, it is conceivable that a video displayed using a large screen is used as the first video 250. Alternatively, it is conceivable that a video which includes many actions is used as the first video 250. Still alternatively, it is conceivable that the line of sight of the viewer is detected by using a camera (not shown) separately provided in the device and the video that the viewer is viewing is used as the first video 250. Still alternatively, when the device is provided with an audio output, it is conceivable that the video corresponding to the outputted sound is used as the first video 250.

Further, when the second video 260 included in the input video signal 2 is composed of a two-dimensional video, the parallax change section 245 may convert the second video 260 into a three-dimensional video, to have the parallax between the right-eye video and the left-eye video in the first video 250. Accordingly, the parallax between the right-eye video and the left-eye video in the first video 250 and the parallax between the right-eye video and the left-eye video in the second video 260 become the same. The video control section 240 may have the configuration shown in FIG. 9C.

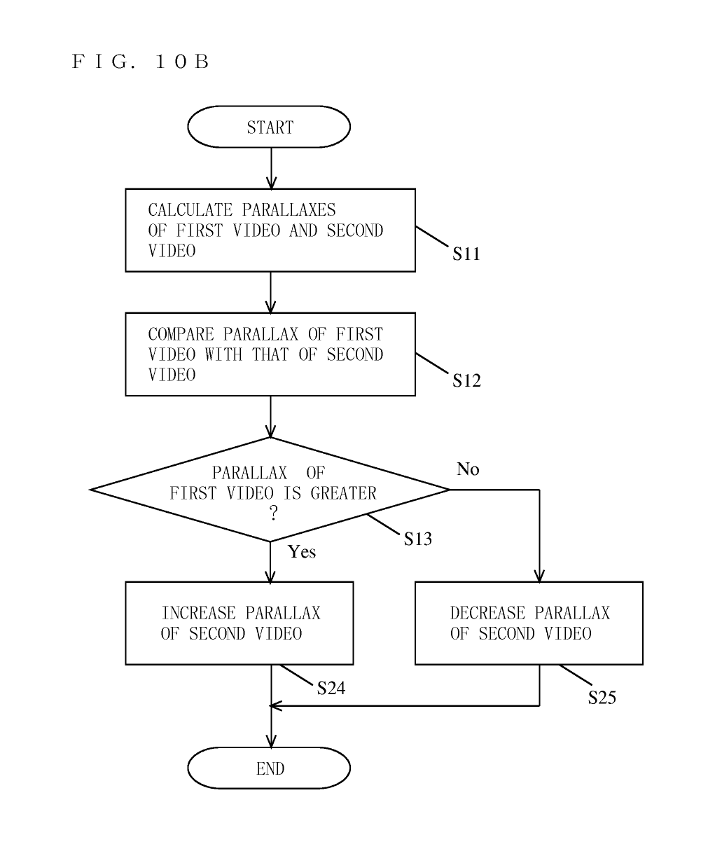

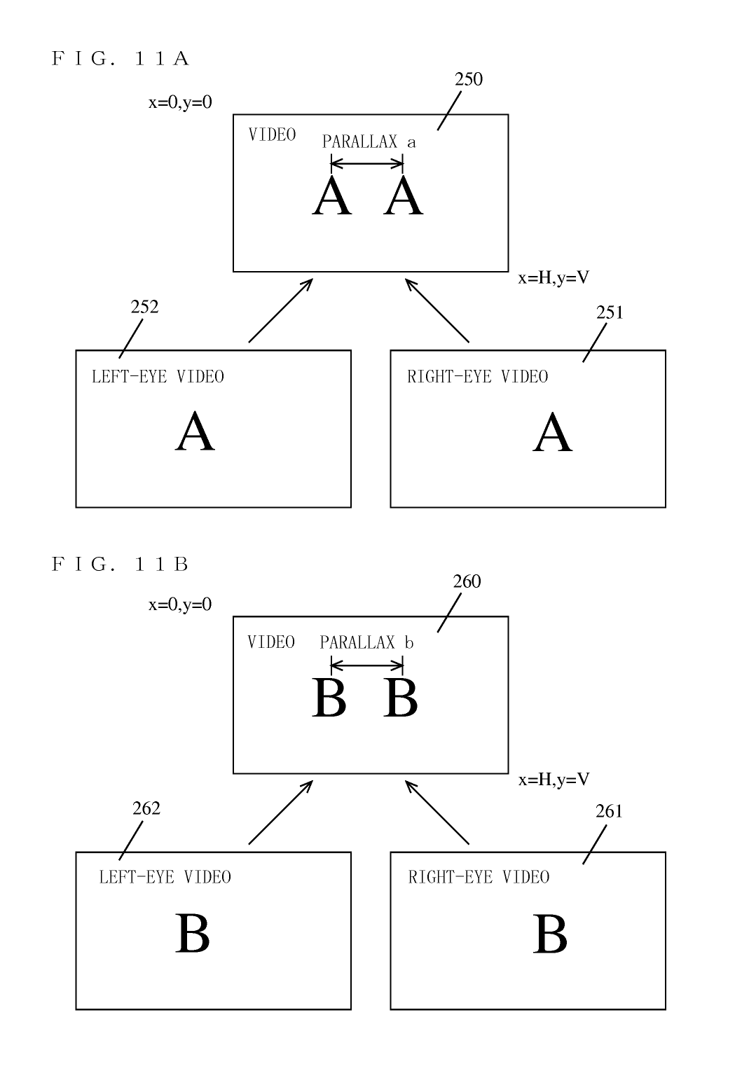

Next, operations performed by the stereoscopic video display device 200 will be described. FIG. 10A is a flow chart showing an example of operations performed by the stereoscopic video display device 200 when it adjusts the parallax. In FIG. 10A, the parallax calculation sections 241 and 242 calculate the parallax between the right-eye video 251 and the left-eye video 252 of the first video 250 and the parallax between the right-eye video 261 and the left-eye video 262 of the second video 260, respectively (step S11).

Next, the parallax control section 243 compares the parallax between the right-eye video 251 and the left-eye video 252 of the first video 250 with the parallax between the right-eye video 261 and the left-eye video 262 of the second video 260 (step S12). When the parallax between the right-eye video 251 and the left-eye video 252 of the first video 250 is greater than the parallax between the right-eye video 261 and the left-eye video 262 of the second video 260 (step S13: Yes), the parallax control section 243 controls the parallax change section 244 so as to decrease the parallax between the right-eye video 251 and the left-eye video 252 of the first video 250 (step S 14). On the other hand, when the parallax between the right-eye video 251 and the left-eye video 252 of the first video 250 is not greater than the parallax between the right-eye video 261 and the left-eye video 262 of the second video 260 (step S13: No), the parallax control section 243 controls the parallax change section 245 so as to increase the parallax between the right-eye video 251 and the left-eye video 252 of the first video 250 (step S15).

In the example shown in FIG. 10A, the parallax between the right-eye video 251 and the left-eye video 252 of the first video 250 is controlled as a result of the comparison between the parallax between the right-eye video 251 and the left-eye video 252 of the first video 250 and the parallax between the right-eye video 261 and the left-eye video 262 of the second video 260. However, the parallax between the right-eye video 261 and the left-eye video 262 of the second video 260 may be controlled (see FIG. 10B). In FIG. 10B, the operations of steps S11 to S13 are the same as those in FIG. 10A, and thus, description thereof will be omitted. When the parallax between the right-eye video 251 and the left-eye video 252 of the first video 250 is greater than the parallax between the right-eye video 261 and the left-eye video 262 of the second video 260 (step S13: Yes), the parallax control section 243 controls the parallax change section 245 so as to increase the parallax between the right-eye video 261 and the left-eye video 262 of the second video 260 (step S24). On the other hand, when the parallax between the right-eye video 251 and the left-eye video 252 of the first video 250 is not greater than the parallax between the right-eye video 261 and the left-eye video 262 of the second video 260 (step S13: No), the parallax control section 243 controls the parallax change section 245 so as to increase the parallax between the right-eye video 261 and the left-eye video 262 of the second video 260 (step S25).

Further, the operations of the stereoscopic video display device 200 may be a combination of the processes shown in FIG. 10A and FIG. 10B. Specifically, in the stereoscopic video display device 200, when the parallax between the right-eye video 251 and the left-eye video 252 of the first video 250 is greater than the parallax between the right-eye video 261 and the left-eye video 262 of the second video 260 (step S13: Yes), the parallax control section 243 controls the parallax change sections 244 and 245 so as to decrease the parallax between the right-eye video 251 and the left-eye video 252 of the first video 250 and to increase the parallax between the right-eye video 261 and the left-eye video 262 of the second video 260. On the other hand, when the parallax between the right-eye video 251 and the left-eye video 252 of the first video 250 is not greater than the parallax between the right-eye video 261 and the left-eye video 262 of the second video 260 (step S13: No), the parallax control section 243 controls the parallax change sections 244 and 245 so as to increase the parallax between the right-eye video 251 and the left-eye video 252 of the first video 250 and to decrease the parallax between the right-eye video 261 and the left-eye video 262 of the second video 260.

As described above, when the parallax between the right-eye video 251 and the left-eye video 252 of the first video 250 is greater than the parallax between the right-eye video 261 and the left-eye video 262 of the second video 260, the parallax between the right-eye video 251 and the left-eye video 252 of the first video 250 is decreased and the parallax between the right-eye video 261 and the left-eye video 262 of the second video 260 is increased. Accordingly, the difference between the parallax between the right-eye video 251 and the left-eye video 252 of the first video 250 and the parallax between the right-eye video 261 and the left-eye video 262 of the second video 260 is decreased and the uncomfortableness felt by the viewer can be decreased.

At this time, in particular, in order to cause the difference between the parallax between the right-eye video 251 and the left-eye video 252 of the first video 250 and the parallax between the right-eye video 261 and the left-eye video 262 of the second video 260 to fall within a predetermined range, the parallaxes may be adjusted so as to be decreased or increased. As the predetermined range, an appropriate range for which a viewer feels less uncomfortable may be set in advance.

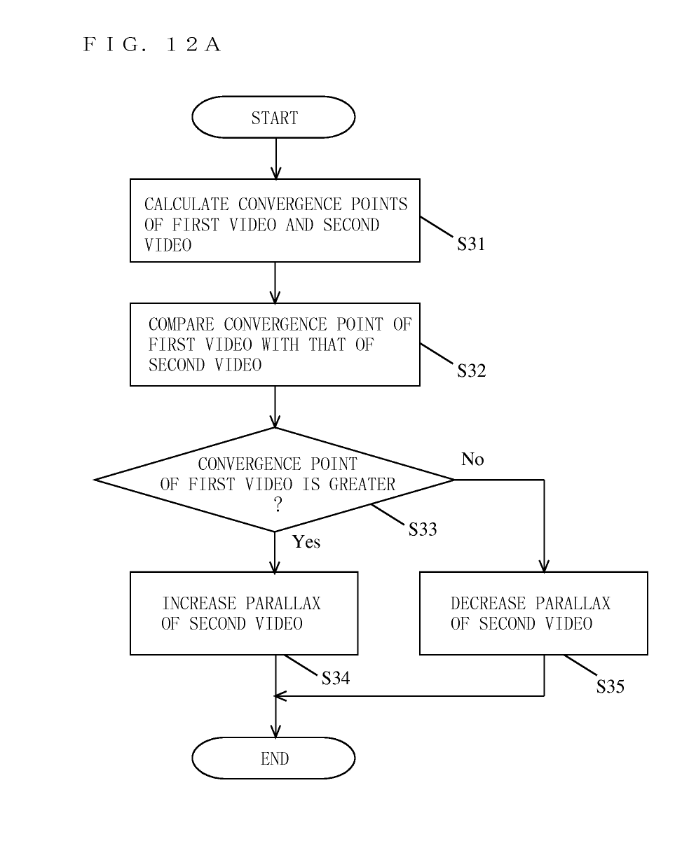

Moreover, the parallax described above may be defined as a convergence point to be described below. In this case, the video control section 240 calculates the convergence point of each of the plurality of stereoscopic video footages, and adjusts the parallaxes of the plurality of stereoscopic video footages based on the calculated convergence points. Specifically, the parallax calculation section 241 calculates the convergence point of the first video 250. The parallax calculation section 242 calculates the convergence point of the second video 260. The convergence point of the first video 250 and the convergence point of the second video 260 can be calculated by the following method. FIG. 11A shows a method of calculating the convergence point of the first video 250. FIG. 11B shows a method of calculating the convergence point of the second video 260. Here, it is assumed that the x-coordinates in the first video 250 and the second video 260 range from 0 to H and the y-coordinates in the first video 250 and the second video 260 range from 0 to V. H represents a count of horizontal effective pixels in the first video 250 and the second video 260, and V represents a count of vertical effective pixels in the first video 250 and the second video 260.

With reference to FIG. 11A, the parallax between the right-eye video 251 and the left-eye video 252 at any given x, y coordinates in the first video 250 is assumed to be a. With reference to FIG. 11B, the parallax between the right-eye video 261 and the left-eye video 262 at any given x, y coordinates in the second video 260 is assumed to be b. At this time, the parallax calculation section 241 can calculate the convergence point of the first video 250 by use of (expression 1). Moreover, the parallax calculation section 242 can calculate the convergence point of the second video 260 by use of (expression 2). Here, time T may be any given time period, and an appropriate range for which the viewer feels less uncomfortable may be set in advance.

$$\begin{matrix}[ Expression 1 ] & \\ Convergence point = {\sum }^{T} ( {\sum }_{x = 0 , y = 0}^{x = H , y = V} a ) / T & ( Expression 1 ) \\ [ Expression 2 ] & \\ Convergence point = {\sum }^{T} ( {\sum }_{x = 0 , y = 0}^{x = H , y = V} b ) / T & ( Expression 2 )\end{matrix}$$

Next, the parallax control section 243 controls the parallax between the right-eye video and the left-eye video in the first video 250 or the second video 260 so as to decrease or increase the value of the convergence point of the first video 250 or the second video 260, in accordance with the value of the convergence point of the first video 250 or the second video 260. As a specific example, the parallax control section 243 compares the convergence point of the first video 250 with the convergence point of the second video 260, and controls the parallax between the right-eye video and the left-eye video in the first video 250 such that the convergence point of the first video 250 coincides with the convergence point of the second video 260. Instead, the parallax control section 243 may control the parallax between the right-eye video and the left-eye video in the second video 260 such that the convergence point of the second video 260 coincides with the convergence point of the first video 250.

Alternatively, the parallax control section 243 may calculate a middle point between the convergence point of the first video 250 and the convergence point of the second video 260, and may control the parallax between the right-eye video and the left-eye video in the first video 250 and the second video 260 such that the convergence point of the first video 250 and the convergence point of the second video 260 coincide with the middle point. Still alternatively, the parallax control section 243 may control the convergence point of the first video 250 and the convergence point of the second video 260 such that they coincide with a predetermined value.

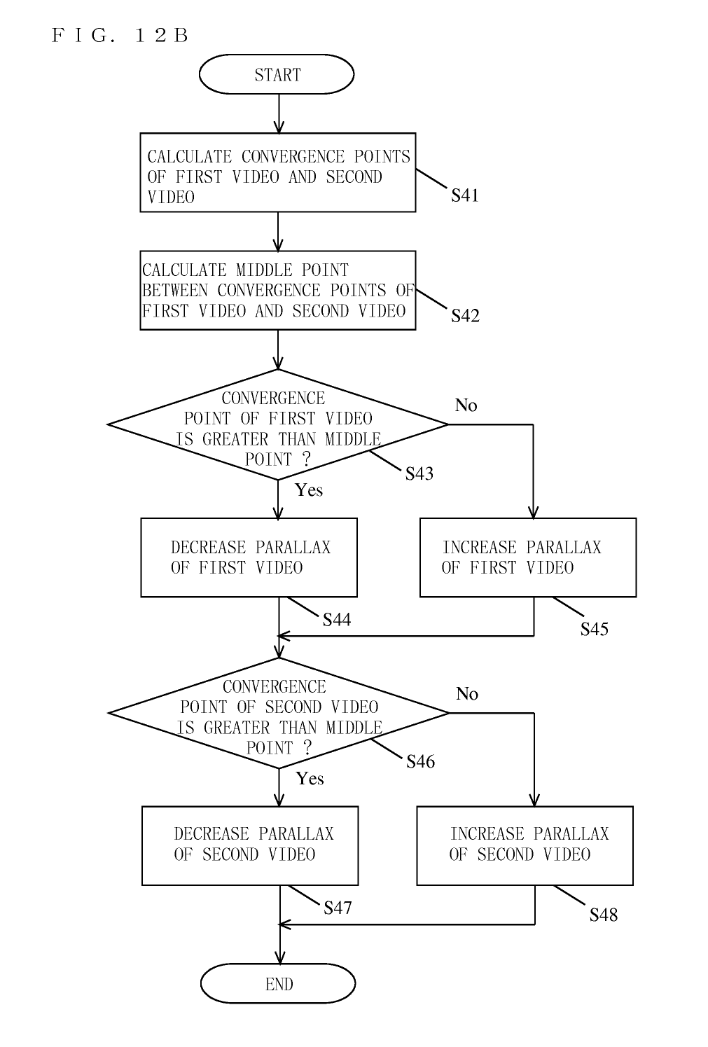

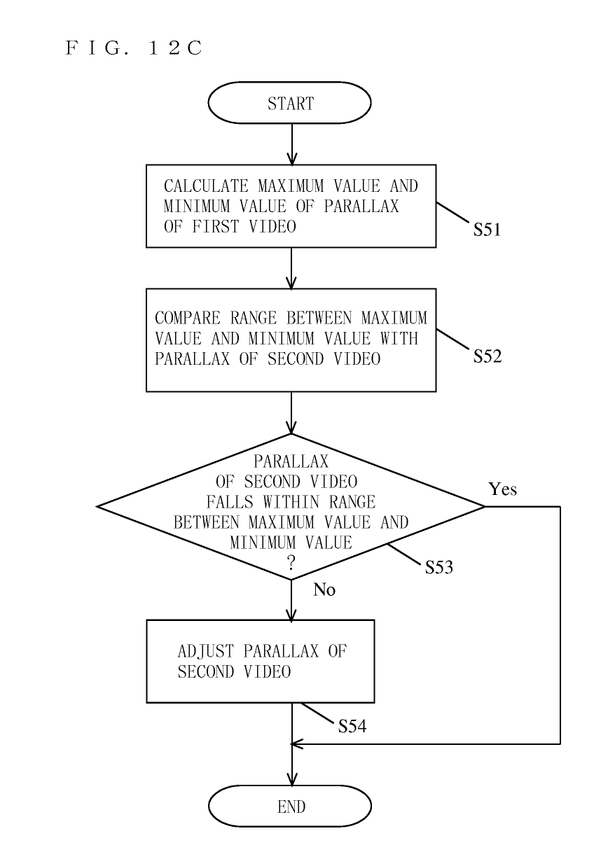

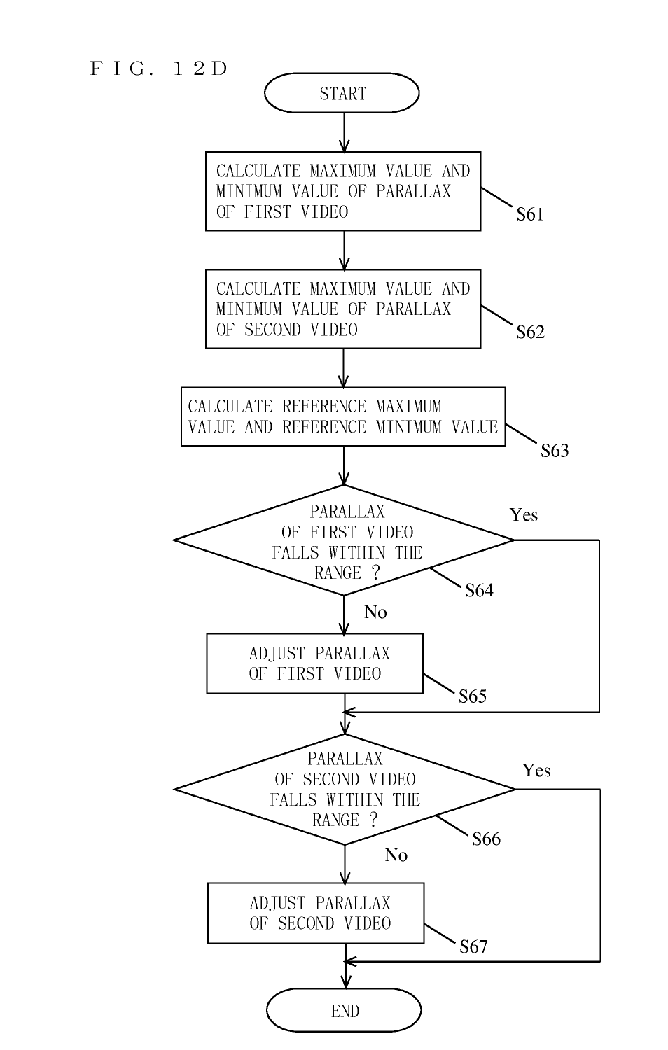

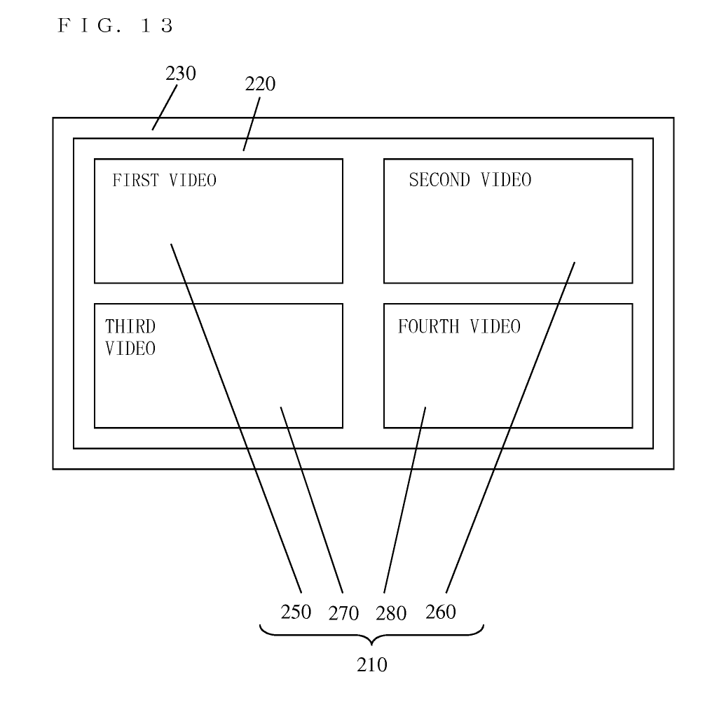

FIG. 12A is a flow chart showing an example of operations performed by the stereoscopic video display device 200 when it adjusts the convergence point of the second video 260 to the convergence point of the first video 250. With reference to FIG. 12A, the parallax calculation sections 241 and 242 calculate the convergence point of the first video 250 and the convergence point of the second video 260, respectively (step S31). The parallax control section 243 compares the convergence point of the first video 250 with the convergence point of the second video 260 (step S32). When the value of the convergence point of the first video 250 is greater than that of the convergence point of the second video 260 (step S33: Yes), the parallax control section 243 increases the parallax between the right-eye video and the left-eye video in the second video 260 such that the convergence point of the second video 260 coincides with the convergence point of the first video 250 (step S34). On the other hand, when the value of the convergence point of the first video 250 is not greater than that of the convergence point of the second video 260 (step S33: No), the parallax control section 243 decreases the parallax between the right-eye video and left-eye video in the second video 260 such that the convergence point of the second video 260 coincides with the convergence point of the first video 250 (step S35). It should be noted that, although the convergence point of the second video 260 is caused to coincide with the convergence point of the first video 250 in the above flow chart, the convergence point of the first video 250 may be caused to coincide with the convergence point of the second video 260.

FIG. 12B is a flow chart showing an example of operations performed by the stereoscopic video display device 200 when it causes the convergence point of the first video 250 and the convergence point of the second video 260 to coincide with the middle point. Here, the middle point is expressed by an average of the convergence point of the first video 250 and the convergence point of the second video 260. With reference to FIG. 12B, the parallax calculation sections 241 and 242 calculate the convergence point of the first video 250 and the convergence point of the second video 260, respectively (step S41). The parallax control section 243 calculates the middle point between the convergence point of the first video 250 and the convergence point of the second video 260 (step S42). Next, the parallax control section 243 compares the convergence point of the first video 250 with the calculated middle point, and when the value of the convergence point of the first video 250 is greater than that of the middle point (step S43: Yes), the parallax control section 243 decreases the parallax between the right-eye video and the left-eye video in the first video 250 such that the convergence point of the first video 250 coincides with the calculated middle point (step S44). On the other hand, when the value of the convergence point of the first video 250 is not greater than that of the middle point (step S43: No), the parallax control section 243 increases the parallax between the right-eye video and the left-eye video in the first video 250 such that the convergence point of the first video 250 coincides with the calculated middle point (step S45).

Further, the parallax control section 243 compares the convergence point of the second video 260 with the calculated middle point, and when the value of the convergence point of the second video 260 is greater than that of the middle point (step S46: Yes), the parallax control section 243 decreases the parallax between the right-eye video and the left-eye video in the second video 260 such that the convergence point of the second video 260 coincides with the calculated middle point (step S47). On the other hand, when the value of the convergence point of the second video 260 is not greater than that of the middle point (step S46: No), the parallax control section 243 increases the parallax between the right-eye video and the left-eye video in the second video 260 such that the convergence point of the second video 260 coincides with the calculated middle point (step S48). It should be noted that, although the convergence point of the first video 250 and the convergence point of the second video 260 are caused to coincide with the middle point in the flow chart described above, the convergence point of the first video 250 and the convergence point of the second video 260 may be controlled so as to coincide with a predetermined value.

It should be noted that, as the convergence point of the first video 250, an average value of the parallaxes of the plurality of objects 255a, 255b, and 255c in the first video 250 may be used. Similarly, as the convergence point of the second video 260, an average value of the parallaxes of the plurality of objects 265a, 265b, 265c, 265d, and 265e in the second video 260 may be used.

Specifically, when the parallaxes are to be adjusted, the following means may be employed, for example. First, a pixel (referred to as pixel (ii)) in the left-eye video 252 corresponding to a pixel in the right-eye video 251 (referred to as pixel (i)) is specified. Here, the corresponding pixels are pixels that represent the same point of the subject. That is, with reference to FIG. 3, it is possible to say that the parallax between pixels each forming the vertex of the character A is W1. Lastly, by adjusting a horizontal coordinate that represents either the pixel (i) in the right-eye video 251 or the pixel (ii) in the left-eye video 252, the parallax between the pixels can be adjusted. By applying this adjustment of the parallax between the pixels to the pixels forming each video, the parallax between the stereoscopic video footages can be adjusted. As another means, for example, if the relative position between the right-eye video 251 and the left-eye video 252 in the first video 250 is changed, or the relative position between the right-eye video 261 and the left-eye video 262 in the second video 260 is changed, the parallax between the right-eye video 251 and the left-eye video 252 of the first video 250 or the parallax between the right-eye video 261 and the left-eye video 262 of the second video 260 is changed. That is, the parallax between the right-eye video 251 and the left-eye video 252 of the first video 250 and the parallax between the right-eye video 251 and the left-eye video 252 of the second video 260 can be adjusted.

Moreover, if the relative position only between an object 255 in the right-eye video 251 and the corresponding object 255 in the left-eye video 252 of the first video 250 is changed, or if the relative position only between an object 265 in the right-eye video 261 and the corresponding object 265 in the left-eye video 262 of the second video 260 is changed, the parallax of the object 255 in the first video 250 or the parallax of the object 265 in the second video 260 is changed. In this manner, the parallax between the right-eye video 251 and the left-eye video 252 of the first video 250 and the parallax between the right-eye video 261 and the left-eye video 262 of the second video 260 can be adjusted.

In the example shown in FIG. 8, objects 255 in the first video 250 or objects 265 in the second video 260 whose parallaxes need to be adjusted are selected. Then, the objects 255a, 255b, 255c, and 265e having larger parallaxes are changed into objects having decreased parallaxes, and the objects 265a, 265b, 265c, and 265d having decreased parallaxes are changed into objects having larger parallaxes. It should be noted, in FIG. 8, the objects 255a, 255b, 255c, and 265e having larger outer diameters correspond to the objects having larger parallaxes, and the objects 265a, 265b, 265c, and 265d having smaller outer diameters correspond to the objects having smaller parallaxes.

As described above, the parallax of the first video 250 or the second video 260 is adjusted by changing the relative position between the right-eye video 251 and the left-eye video 252 in the first video 250 or the relative position between the right-eye video 261 and the left-eye video 262 in the second video 260, or by changing the relative position only between objects 255 in the right-eye video 251 and the left-eye video 252 of the first video 250 or the relative position only between objects 265 in the right-eye video 261 and the left-eye video 262 of the second video 260.

Moreover, when adjusting parallaxes, the stereoscopic video display device 200 may operate in the following manner. Specifically, the video control section 240 controls the parallax between the right-eye video and the left-eye video in the second video 260 such that the parallax between the right-eye video and the left-eye video in the second video 260 falls within a range between the maximum value (Max1) and the minimum value (Min1) of the parallax between the right-eye video and the left-eye video in the first video 250. Instead, the video control section 240 may control the parallax between the right-eye video and the left-eye video in the first video 250 such that the parallax between the right-eye video and the left-eye video in the first video 250 falls within a range between the maximum value (Max2) and the minimum value (Min2) of the parallax between the right-eye video and the left-eye video in the second video 260.

Alternatively, the video control section 240 may control parallaxes in the following manner. The video control section 240 calculates a middle value between the minimum value (Min1) of the parallax between the right-eye video and the left-eye video in the first video 250 and the minimum value (Min2) of the parallax between the right-eye video and the left-eye video in the second video 260, as a reference minimum value (Min). Further, the video control section 240 calculates a middle value between the maximum value (Max1) of the parallax between the right-eye video and the left-eye video in the first video 250 and the maximum value (Max2) of the parallax between the right-eye video and the left-eye video in the second video 260, as a reference maximum value (Max). Then, the video control section 240 controls the parallax between the right-eye video and the left-eye video in the first video 250 and the parallax between the right-eye video and the left-eye video in the second video 260 such that they fall within a range between the reference maximum value (Max) and the reference minimum value (Min).

Alternatively, the video control section 240 may control the parallax between the right-eye video and the left-eye video in the first video 250 and the parallax between the right-eye video and the left-eye video in the second video 260 such that they fall within a range between a preset maximum value and a preset minimum value.

FIG. 12C is a flow chart showing an example of operations performed by the stereoscopic video display device 200 when it causes the parallax between the right-eye video and the left-eye video in the second video 260 to fall within a range between the maximum value (Max1) and the minimum value (Min1) of the parallax between the right-eye video and the left-eye video in the first video 250. With reference to FIG. 12C, the parallax calculation section 241 calculates the maximum value (Max1) and the minimum value (Min1) of the parallax between the right-eye video and the left-eye video in the first video 250, based on the input video signal 1. Moreover, the parallax calculation section 242 calculates the parallax between the right-eye video and the left-eye video in the second video 260, based on the input video signal 2 (step S51).

Next, the parallax control section 243 compares the range between the maximum value (Max1) and the minimum value (Min1) of the parallax between the right-eye video and the left-eye video in the first video 250 with the parallax between the right-eye video and the left-eye video in the second video 260 (step S52). When the parallax between the right-eye video and the left-eye video in the second video 260 does not fall within the range (step S53: No), the parallax control section 243 adjusts the parallax between the right-eye video and the left-eye video in the second video 260 so as to fall within the range (step S54). On the other hand, when the parallax between the right-eye video and the left-eye video in the second video 260 falls within the range (step S53: Yes), the parallax control section 243 ends the process without adjusting the parallax between the right-eye video and the left-eye video in the second video 260. In the flow chart described above, the parallax between the right-eye video and the left-eye video in the second video 260 is adjusted so as to fall within the range between the maximum value and the minimum value of the parallax of the first video 250. However, the parallax between the right-eye video and the left-eye video in the first video 250 may be adjusted so as to fall within the range between the maximum value and the minimum value of the parallax of the second video 260.

FIG. 12D is a flow chart showing an example of operations performed by the stereoscopic video display device 200 when it causes the parallaxes of the first video 250 and the second video 260 to fall within a range between the reference maximum value (Max) and the reference minimum value (Min). With reference to FIG. 12D, the parallax calculation section 241 calculates the maximum value (Max1) and the minimum value (Min1) of the parallax between the right-eye video and the left-eye video in the first video 250, based on the input video signal 1 (step S61). The parallax calculation section 242 calculates the maximum value (Max2) and the minimum value (Min2) of the parallax between the right-eye video and the left-eye video in the second video 260, based on the input video signal 2 (step S62).

The parallax control section 243 calculates a middle value between the minimum value (Min1) of the parallax between the right-eye video and the left-eye video in the first video 250 and the minimum value (Min2) of the parallax between the right-eye video and the left-eye video in the second video 260, as a reference minimum value (Min). Moreover, the video control section 240 calculates a middle value between the maximum value (Max1) of the parallax between the right-eye video and the left-eye video in the first video 250 and the maximum value (Max2) of the parallax between the right-eye video and the left-eye video in the second video 260, as a reference maximum value (Max) (step S63).

The parallax control section 243 determines whether the parallax between the right-eye video and the left-eye video in the first video 250 falls within the range between the reference maximum value (Max) and the reference minimum value (Min) (step S64). When the parallax between the right-eye video and the left-eye video in the first video 250 does not fall within the range (step S64: No), the parallax control section 243 adjusts the parallax between the right-eye video and the left-eye video in the first video 250 so as to fall within the range (step S65). On the other hand, when the parallax between the right-eye video and the left-eye video in the first video 250 falls within the range (step S64: Yes), the parallax control section 243 ends the process without adjusting the parallax between the right-eye video and the left-eye video in the first video 250.

Further, the parallax control section 243 determines whether the parallax between the right-eye video and the left-eye video in the second video 260 falls within the range between the reference maximum value (Max) and the reference minimum value (Min) (step S66). When the parallax between the right-eye video and the left-eye video in the first video 250 does not fall within the range (step S66: No), the parallax control section 243 adjusts the parallax between the right-eye video and the left-eye video in the second video 260 so as to fall within the range (step S67). On the other hand, when the parallax between the right-eye video and the left-eye video in the second video 260 falls within the range (step S66: Yes), the parallax control section 243 ends the process without adjusting the parallax between the right-eye video and the left-eye video in the second video 260. In the flow chart described above, the parallaxes of the first video 250 and the second video 260 are caused to fall within the range between the reference maximum value (Max) and the reference minimum value (Min). However, the parallaxes of the first video 250 and the second video 260 may be caused to fall within a range between a preset maximum value and a preset minimum value. As the range between the preset maximum value and the preset minimum value, an appropriate range for which a viewer feels less uncomfortable may be preset.

### SUMMARY

According to the above configurations, the video control section 240 simultaneously displays the first video 250 and the second video 260 in given positions on the screen 220. This allows a viewer to simultaneously view a plurality of stereoscopic video footages, and thus, convenience is improved.

In particular, in accordance with the parallax between the right-eye video 251 and the left-eye video 252 of the first video 250, the video control section 240 performs adjustment so as to decrease or increase the parallax between the right-eye video 251 and the left-eye video 252 of the first video 250, or performs adjustment so as to decrease or increase the parallax between the right-eye video 261 and the left-eye video 262 of the second video 260. Accordingly, even when a viewer simultaneously views the first video 250 and the second video 260 having different sense of depth and different sense of projection, the viewer can feel less uncomfortable.

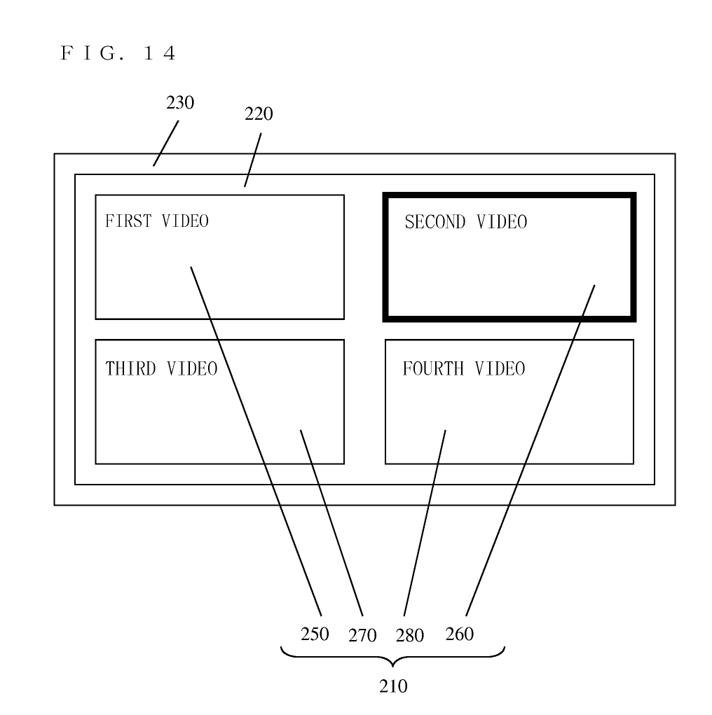

In the present embodiment, two video footages 210, that is, the first video 250 and the second video 260, are displayed on the screen 220. However, as shown in FIG. 13, more video footages 210 may be simultaneously displayed on the screen 220, and parallaxes may be adjusted in the same manner as described above. In the example shown in FIG. 13, the stereoscopic video display device 200 simultaneously displays the first video 250, the second video 260, third video 270, and fourth video 280 on the screen 220.

Further, the first video 250 and the second video 260 are displayed by reducing the whole of the original video 210. However, parts of the original video 210 may be displayed. Reduction rates and magnification rates of the first video 250 or the second video 260 relative to the original video 210 may be freely set.

Further, the video control section 240 may adjust the parallax between the right-eye video 251 and the left-eye video 252 of the first video 250 or adjust the parallax between the right-eye video 261 and the left-eye video 262 of the second video 260, such that, among the plurality of the video footages 210, a difference between the parallax between the right-eye video 251 and the left-eye video 252 of the first video 250 and the parallax between the right-eye video 261 and the left-eye video 262 of the second video 260 falls within a predetermined range.

Further, the video control section 240 may adjust the parallax between the right-eye video 251 and the left-eye video 252 of the first video 250 or adjust the parallax between the right-eye video 261 and the left-eye video 262 of the second video 260, such that, among the plurality of the video footages 210, the parallax between the right-eye video 251 and the left-eye video 252 of the first video 250 becomes equal to the parallax between the right-eye video 261 and the left-eye video 262 of the second video 260.

Further, the video control section 240 may adjust the parallax between the right-eye video 251 and the left-eye video 252 of the first video 250 or adjust the parallax between the right-eye video 261 and the left-eye video 262 of the second video 260, such that, among the plurality of the video footages 210, the parallax between the right-eye video 251 and the left-eye video 252 of the first video 250 and the parallax between the right-eye video 261 and the left-eye video 262 of the second video 260 become equal to a preset reference parallax.

Further, the video control section 240 may adjust the parallax between the right-eye video 251 and the left-eye video 252 of the first video 250 or adjust the parallax between the right-eye video 261 and the left-eye video 262 of the second video 260, such that, among the plurality of the video footages 210, the value of the convergence point of the first video 250 becomes equal to the value of the convergence point of the second video 260.

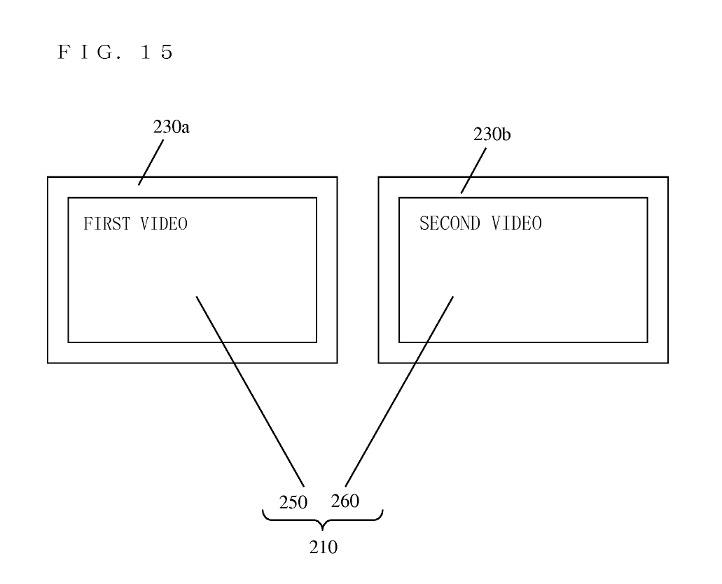

Further, the stereoscopic video display device 200 may cause thumbnails of a plurality of the stereoscopic video footages 210 to be displayed on the screen 220, and when a viewer selects a stereoscopic video, the stereoscopic video display device 200 may adjust the parallax of the selected stereoscopic video to change its sense of depth and sense of projection. FIG. 14 is a front view of the display panel 230 when a plurality of stereoscopic video footages are displayed in thumbnails. In the example shown in FIG. 14, it is assumed that the viewer has selected the second video 260 by using an input device such as a remote control. At this time, by increasing the parallax between the right-eye video 261 and the left-eye video 262 of the second video 260 so as to have a greater value than the parallax of the left-eye video and the right-eye video of each of the first video 250, the third video 270, and the fourth video 280, the video control section 240 can cause the second video 260 to be distinguished from the first video 250, the third video 270, and the fourth video 280. Alternatively, by decreasing the parallax between the right-eye video and the left-eye video in each of the first video 250, the third video 270, and the fourth video 280, the video control section 240 may cause the second video 260 to be distinguished from the first video 250, the third video 270, and the fourth video 280. This allows the viewer to freely select one from the plurality of stereoscopic video footages, whereby convenience is improved.

Further, the stereoscopic video display device 200 according to the present invention can be applied to a case where a plurality of display panels are used. FIG. 15 is a front view of a plurality of display panels at a time when video footages are displayed on the stereoscopic video display devices 200, respectively. In FIG. 15, a first display panel 230a displays the first video 250. A second display panel 230b displays the second video 260. By using the methods described above, the stereoscopic video display device 200 adjusts the parallax between the right-eye video 251 and the left-eye video 252 of the first video 250 and the parallax between the right-eye video 261 and the left-eye video 262 of the second video 260.

It should be noted that the process procedures performed by the stereoscopic video display device 200 described in one embodiment of the present invention may be realized by a CPU interpreting and executing predetermined program data capable of executing the above-described process procedures stored on a storage device (a ROM, a RAM, and a hard disk, and the like). In this case, the program data may be loaded onto the storage device via a storage medium, or may be directly executed on the storage medium. Here, the storage medium includes: a semiconductor memory such as a ROM, a RAM, a flash memory; a magnetic disk memory such as a flexible disk and a hard disk; an optical disk memory such as a CD-ROM, a DVD, and a BD; a memory card; and the like. Further the storage medium is a notion including a communication medium such as a telephone line, a carrier path, and the like.

Further, in one embodiment of the present invention, the functional blocks forming the stereoscopic video display device 200 are realized as a program that runs on a CPU (or a processor)). A part or the whole of the functions may be realized as LSIs, which are integrated circuits. Each LSI may be realized in one chip, or some or the whole of these LSIs may be realized in one chip. The LSI may be referred to as an IC, a system LSI, a super LSI, an ultra LSI depending on the degree of integration.

Further, the method of integration is not limited to LSI, and may be realized by a dedicated circuit or a general purpose processor. Alternatively, an FPGA (FIELD PROGRAMMABLE GATE ARRAY) which is programmable after the LSI has been manufactured, or a reconfigurable processor enabling reconfiguration of connection or setting of circuit cells in the LSI may be used.

Still further, in a case where another integration technology replacing the LSI becomes available due to an improvement of a semiconductor technology or due to emergence of another technology derived therefrom, the functional blocks may be integrated using such a new technology. For example, biotechnology may be applied.

### INDUSTRIAL APPLICABILITY

The present invention can be applied to a stereoscopic video display device and the like with improved convenience which allows a viewer to simultaneously view a plurality of stereoscopic video footages.

### DESCRIPTION OF THE REFERENCE CHARACTERS

100 visor

200 stereoscopic video display device

210 video

211 right-eye video

212 left-eye video

220 screen

230, 230a, 230b display panel

240 video control section

241, 242 parallax calculation section

243 parallax control section

244, 245 parallax change section

250 first video

251 right-eye video

252 left-eye video

255 object

255a object

255b object

255c object

260 second video

261 right-eye video

262 left-eye video

265a object

265b object

265c object

265d object

265e object

270 third video

280 fourth video

1. A stereoscopic video display device configured to display a plurality of stereoscopic video footages, comprising:
a display panel in which a screen for displaying the plurality of stereoscopic video footages is arranged; and
a video control section configured to control the display of the plurality of stereoscopic video footages; wherein
the plurality of stereoscopic video footages respectively include right-eye video and left-eye video each having parallax with respect to the other, and
the video control section
simultaneously displays the plurality of stereoscopic video footages in given positions on the screen, and
changes, in accordance with the parallax between the right-eye video and the left-eye video in one stereoscopic video footage among the plurality of stereoscopic video footages, the parallax between the right-eye video and the left-eye video in said one stereoscopic video footage or in another of the stereoscopic video footages, so as to decrease or increase the parallax between the right-eye video and the left-eye video in said one stereoscopic video footage or in said other stereoscopic video footage.

2. The stereoscopic video display device according to claim 1, wherein
the video control section changes the parallax between the right-eye video and the left-eye video in said one stereoscopic video footage or in said other stereoscopic video footage in such a way that, among the plurality of stereoscopic video footages, a difference between the parallax between the right-eye video and the left-eye video in said one stereoscopic video footage and the parallax between the right-eye video and the left-eye video in said other stereoscopic video footage falls within a predetermined range.

3. The stereoscopic video display device according claim 1, wherein
the video control section changes the parallax between the right-eye video and the left-eye video in said one stereoscopic video footage or in said other stereoscopic video footage in such a way that, among the plurality of stereoscopic video footages, the parallax between the right-eye video and the left-eye video in said one stereoscopic video footage becomes equal to the parallax between the right-eye video and the left-eye video in said other stereoscopic video footage.

4. The stereoscopic video display device according claim 1, wherein
the video control section changes the parallax between the right-eye video and the left-eye video in said one stereoscopic video footage or in said other stereoscopic video footage in such a way that, among the plurality of stereoscopic video footages, the parallax between the right-eye video and the left-eye video in said one stereoscopic video footage and the parallax between the right-eye video and the left-eye video in said other stereoscopic video become equal to a preset reference parallax.

5. The stereoscopic video display device according claim 1, wherein
the plurality of stereoscopic video footages include a first video footage and a second video footage; and
the video control section includes
a first parallax calculation section configured to calculate the parallax between the right-eye video and the left-eye video in the first video footage,
a second parallax calculation section configured to calculate the parallax between the right-eye video and the left-eye video in the second video footage,
a parallax control section configured to control the parallax between the right-eye video and the left-eye video in the first video footage or in the second video footage so as to decrease or increase the parallax between the right-eye video and the left-eye video in the first video footage or in the second video footage, in accordance with the parallax between the right-eye video and the left-eye video in the first video footage or in the second video footage,
a first parallax change section configured to change the parallax between the right-eye video and the left-eye video in the first video footage, in accordance with control by the parallax control section, and
a second parallax change section configured to change the parallax between the right-eye video and the left-eye video in the second video footage, in accordance with control by the parallax control section.

6. The stereoscopic video display device according claim 1, wherein
the plurality of stereoscopic video footages include a first video footage and a second video footage; and
the video control section includes
a parallax calculation section configured to calculate the parallax between the right-eye video and the left-eye video in the first video footage, and
a parallax change section configured to change the parallax between the right-eye video and the left-eye video in the second video footage in such a way that it coincides with the parallax between the right-eye video and the left-eye video in the first video footage as calculated by the parallax calculation section.

7. The stereoscopic video display device according claim 1, wherein the video control section changes the parallax between the right-eye video and the left-eye video in said one stereoscopic video footage or in said other stereoscopic video footage so as to decrease or increase, in accordance with a value of a convergence point for said one stereoscopic video footage among the plurality of stereoscopic video footages, a value of the convergence point for said one stereoscopic video footage or a convergence point for said other stereoscopic video footage.

8. The stereoscopic video display device according to claim 7, wherein
the plurality of stereoscopic video footages include a first video footage and a second video footage; and
the video control section includes
a first parallax calculation section configured to calculate the value of the convergence point for the first video footage;
a second parallax calculation section configured to calculate the value of the convergence point for the second video footage;
a parallax control section configured to control the parallax between the right-eye video and the left-eye video in the first video footage or in the second video footage so as to decrease or increase the parallax between the right-eye video and the left-eye video in the first video footage or in the second video footage, in accordance with the value of the convergence point for the first video footage or for the second video footage;
a first parallax change section configured to change the parallax between the right-eye video and the left-eye video in the first video footage in accordance with control by the parallax control section; and
a second parallax change section configured to change the parallax between the right-eye video and the left-eye video in the second video footage in accordance with control by the parallax control section.

9. The stereoscopic video display device according to claim 7, wherein
the plurality of stereoscopic video footages include a first video footage and a second video footage; and
the video control section includes
a parallax calculation section configured to calculate the value of the convergence point for the first video footage, and
a parallax change section configured to change the parallax between the right-eye video and the left-eye video in the second video footage such that it coincides with the value of the convergence point for the first video footage as calculated by the parallax calculation section.

10. The stereoscopic video display device according claim 8, wherein
the first parallax calculation section calculates the value of the convergence point for the first video footage using Expression 1:
$$Convergence point = {\sum }^{T} ( {\sum }_{x = 0 , y = 0}^{x = H , y = V} a ) / T , \qquad ( Expression 1 )$$
wherein T is any given time period, a is the parallax between the right-eye video and the left-eye video at any given x, y coordinates for the first video footage, the x-coordinates range from 0 to a count of horizontal effective pixels for the first video footage and the second video footage, and the y-coordinates range from 0 to a count of vertical effective pixels V for the first video footage and the second video footage.

11. The stereoscopic video display device according to claim 8, wherein
the second parallax calculation section calculates the convergence point for the second video footage using Expression 2:
$$Convergence point = {\sum }^{T} ( {\sum }_{x = 0 , y = 0}^{x = H , y = V} b ) / T , \qquad ( Expression 2 )$$
wherein T is any given time period, b is the parallax between the right-eye video and the left-eye video at any given x, y coordinates for the second video footage, the x-coordinates range from 0 to a count of horizontal effective pixels H for the first video footage and the second video footage, and the y-coordinates range from 0 to a count of vertical effective pixels V for the first video footage and the second video footage.

12. A method performed by a stereoscopic video display device for displaying a plurality of stereoscopic video footages, the method comprising:
a display step of displaying the plurality of stereoscopic video footages on a display-panel screen; and
a control step of controlling the display of the plurality of stereoscopic video footages; wherein
the plurality of stereoscopic video footages respectively include right-eye video and left-eye video each having parallax with respect to the other, and
the control step
simultaneously displays the plurality of stereoscopic video footages in given positions on the screen, and
changes, in accordance with the parallax between the right-eye video and the left-eye video in one stereoscopic video footage among the plurality of stereoscopic video footages, the parallax between the right-eye video and the left-eye video in said one stereoscopic video footage or in another of the stereoscopic video footages, so as to decrease or increase the parallax between the right-eye video and the left-eye video in said one stereoscopic video footage or in said other stereoscopic video footage.

13. The stereoscopic video display device according claim 6, wherein the parallax change section is configured to change the parallax between the right-eye video and the left-eye video in the second video footage in such a way that the second video footage is to be displayed on a plane which is located at a position within the range corresponding to the value of parallax between the right-eye video and the left-eye video in said first video footage.

14. The stereoscopic video display device according claim 9, wherein the parallax change section is configured to change the parallax between the right-eye video and the left-eye video in the second video footage in such a way that the second video footage is to be displayed on a plane located at convergence point for the first video footage.
